(19) United States
(12) Patent Application Publication
(10) Pub. No.: US 2011/0014017 A1
(43) Pub. Date: Jan. 20, 2011

(54) STORAGE RETRIEVAL MACHINE

(75) Inventor: Mark R. Webster, Hubertus, WI (US)

Correspondence Address: MICHAEL BEST & FRIEDRICH LLP, 100 E WISCONSIN AVENUE, Suite 3300, MILWAUKEE, WI, 53202, US

(73) Assignee: PFLOW INDUSTRIES, INC., Milwaukee, WI (US)

(21) Appl. No.: 12/502,732

(22) Filed: Jul. 14, 2009

(51) Int. Cl. B65G 1/04; F16H 1/04

(52) U.S. Cl. 414/267; 74/422

(57) ABSTRACT

A storage retrieval machine comprising an input area, an array of storage locations, an output area, a carriage assembly adapted to hold a product when being transferred to and from the storage locations, and a drive mechanism positioned to move the carriage assembly. The drive mechanism includes a flexible element (e.g., a chain) tensioned between two points and having a plurality of spaced recesses, and a toothed element mounted to the carriage assembly and engaging the flexible element. Preferably, the flexible element is pre-tensioned to a certain percentage of the rated load of the flexible element (e.g., 10%, 20%, 30%, or 40% of the rated load). It is also preferred that the pre-tensioned load on the flexible element is greater than the service load that is anticipated to be applied to the chain during normal operation.

### BACKGROUND

The present invention relates to storage retrieval machines (SRMs), and more specifically to drive mechanisms for such systems.

SRMs are used to automatically store and retrieve items, such as in a warehouse. The storage area typically includes an array of storage locations that are each specifically identified. Each location is capable of storing a single unit, which can be stored or retrieved on command. Such systems commonly have a product input area, a product storage area, and a mechanism for moving products into and out of storage.

Storage areas in SRMs are commonly arranged into rows and columns. As a result, mechanisms that move the products must be capable of both vertical and horizontal movement. Such mechanisms can include, for example, a robotic arm mounted on a platform with both vertical and horizontal actuators. Vertical movement is commonly provided by hydraulic lifts or rack and pinions (e.g., with a driven pinion). Horizontal motion is commonly provided by a driven wheel on a surface, such as a wheel on a rail, which is typically used with overhead cranes in manufacturing environments.

Because precise placement into storage locations is important, the mechanisms that move the product must have a means to determine location. When using positive-position mechanisms, such as a rack and pinion, precise location can be determined by sensing the position of the drive wheel (e.g., counting rotations and detecting angular orientation of a drive pinion on a rack and pinion arrangement). When using other mechanisms where slippage can occur, such as a wheel on rail, the system must use other sensing systems, such as limit switches, to determine position.

### SUMMARY

The present invention provides an SRM drive system that can be used in conjunction with other systems in order to provide an economical means to move products, while at the same time providing positive positioning. In particular, the present invention provides a storage retrieval machine comprising an input area, an array of storage locations, an output area, a carriage assembly adapted to hold a product when being transferred to and from the storage locations, and a drive mechanism positioned to move the carriage assembly. The drive mechanism includes a flexible element (e.g., a chain) tensioned between two points and having a plurality of spaced recesses, and a toothed element mounted to the carriage assembly and engaging the flexible element.

Preferably, the flexible element is pre-tensioned to a certain percentage of the rated load of the flexible element (e.g., 10%, 20%, 30%, or 40% of the rated load). It is also preferred that the pre-tensioned load on the flexible element is greater than the service load that is anticipated to be applied to the chain during normal operation.

Other aspects of the invention will become apparent by consideration of the detailed description and accompanying drawings.

### BRIEF DESCRIPTION OF THE DRAWINGS

FIG. 1 is a perspective view of an SRM embodying features of the invention.

FIG. 2 is a perspective view of a first guide of the SRM of FIG. 1.

FIG. 3 is a perspective view of a second guide of the SRM of FIG. 1.

FIG. 4 is a perspective view of a third guide of the SRM of FIG. 1.

FIG. 5 is a partial perspective view of the SRM of FIG. 1.

FIG. 6 is a partial perspective view of the SRM of FIG. 1.

FIG. 7 is a perspective view of an anchor of the SRM of FIG. 1.

FIG. 8 is a perspective view of a horizontal drive system for another SRM embodying features of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

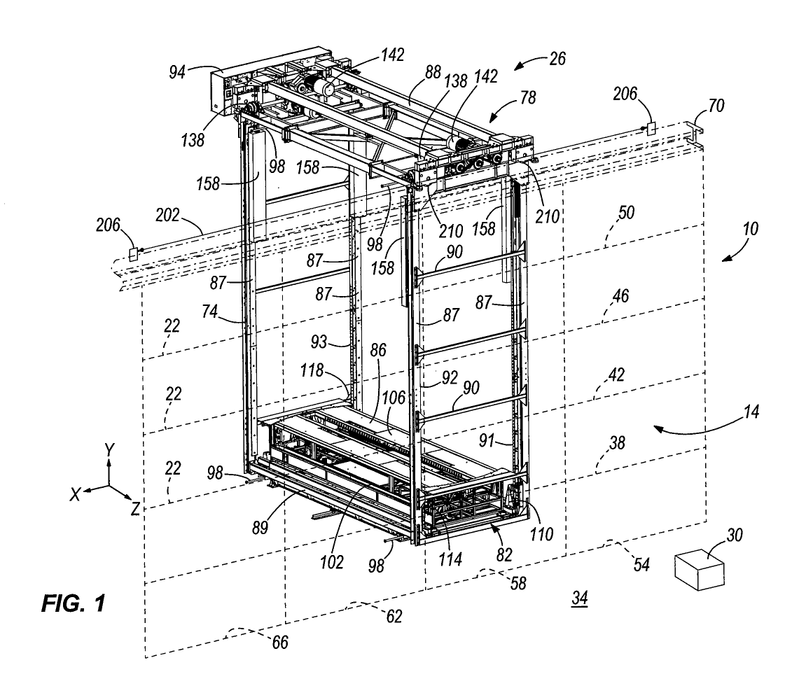

FIG. 1 shows a storage facility 10 including a loading space 14, an array of storage locations 22, and a storage retrieval machine (SRM 26). The loading space 14 is positioned such that a product 30 may access the loading space 14 from a holding area 34. In other embodiments, the storage facility 10 could be different, such as a warehouse, stocking area, car park, or another storage facility as desired. Correspondingly, the array of storage locations 22 could be arranged differently. For example, the array 22 could include any number of columns, any number of rows, or may include a three-dimensional matrix of storage locations. The storage locations could be sized and arranged to hold any product 30, as desired. Additionally, the product 30 could be anything that is advantageously stored, such as cars, boats, produce, toys, or any other appropriate product 30, as desired.

The illustrated storage facility 10 includes four rows and four columns of storage locations 22. The four rows extend along an X-axis and are referred to throughout this application as the first level 38 (i.e., closest to the base), the second level 42, the third level 46, and the fourth level 50 (i.e., farthest from the base). The four columns extend along a Y-axis and are referred to as the first position 54 (i.e., farthest to the right), the second position 58, the third position 62, and the fourth position 66 (i.e., the farthest to the left). A Z-axis is defined perpendicular to the X-axis and the Y-axis (i.e., extending out of the page of FIG. 1 and indicated in the lower left).

A support structure is built into the storage facility 10 and includes rails 70 that support the SRM 26 for movement from the first through fourth positions 54, 58, 62, 66 and from the first through fourth levels 38, 42, 46, 50. In the illustrated embodiment, the support structure is a part of the storage facility 10, and the rails 70 project from the walls of the storage facility 10 to support the SRM 26. In other embodiments, the support structure may be free standing within the storage facility 10 or arranged differently, as desired.

The SRM 26 further includes a SRM frame 74, a carriage assembly 86, an upper drive assembly 78, and a lower drive assembly 82. The SRM frame 74 includes vertical columns 87 that extend from the first level 38 to the fourth level 50, an upper cage 88, and a lower cage 89. The vertical columns 87 connect the upper cage 88 and the lower cage 89 and are further reinforced by struts 90. The upper cage 88 connects the SRM frame 74 to the upper drive assembly 78 such that the upper drive assembly 78 supports the SRM frame 74 for movement on the rails 70, and the lower cage 89 provides a frame work that supports the lower drive assembly 82. The upper and lower cages 88, 89 include additional frame work such that the SRM frame 74 is a rigid structure.

Three of the four vertical columns 87 include guide rails. A first guide rail 91 is attached to one of the vertical columns 87 (lower right in FIG. 1), a second guide rail 92 is attached to another vertical column 87 (lower left in FIG. 1), and a third guide rail 93 is attached to another vertical column 87. The first, second, and third guide rails 91, 92, 93 are formed separately from and are attached to the vertical columns 87. In other embodiments, the first, second, and third guide rails 91, 92, 93 could be formed integrally with the vertical columns 87.

The SRM frame 74 also includes four bumpers in the form of shock absorbers or barriers 98 that cushion and stop the SRM 26 if it moves past the desired location. For example, if the SRM 26 is moving to the fourth position 66 but overshoots the location slightly, the barriers 98 will slow the SRM 26 movement and inhibit damage to the SRM 26 and/or the storage facility 10. In other embodiments, the bumpers may be air bladders, hydraulic cylinders, compressible bumpers, or another type, as desired.

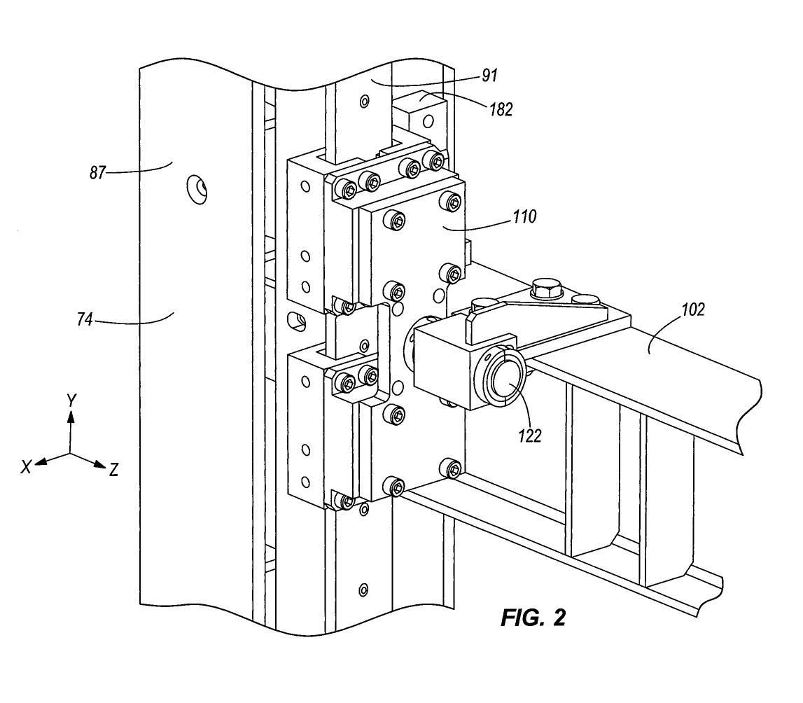

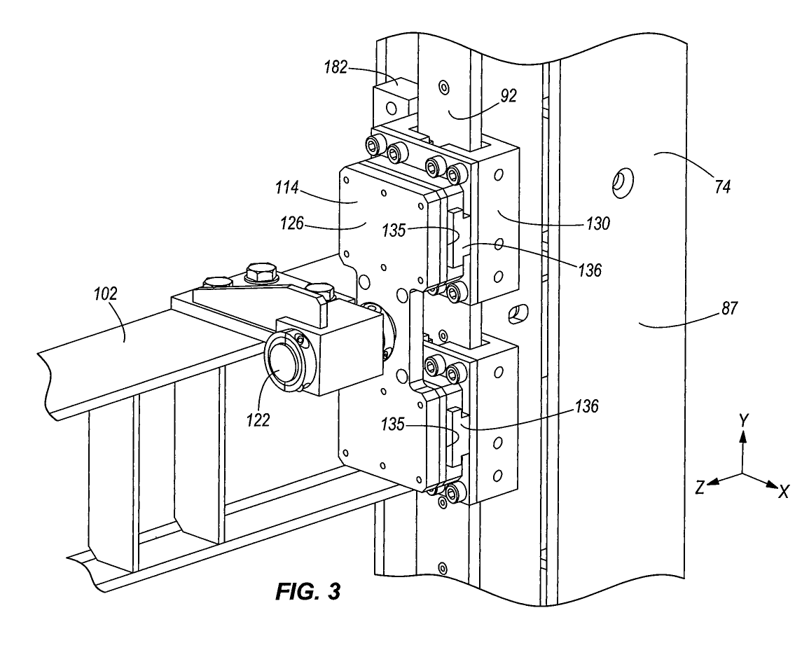

The carriage assembly 86 includes a carriage frame 102 that is supported by the SRM frame 74 and is positioned between the vertical columns 87. The carriage frame 102 includes a first guide member 110 that engages the first guide rail 91, a second guide member 114 that engages the second guide rail 92, and a third guide member 118 that engages the third guide rail 93. The first, second, and third guide members 110, 114, 118 are positioned at three corners of the carriage frame 102 corresponding with the first, second, and third guide rails 91, 92, 93 of the SRM frame 74, and engage the guide rails 91, 92, 93 to guide the carriage assembly 86 during vertical movement of the carriage assembly 86 (i.e., along the Y-axis). FIGS. 3-5 include more details about the interaction between the guide rails 91, 92, 93 and guide members 110, 114, 118 and will be discussed in detail below. The fourth corner of the illustrated carriage frame 102 (upper left in FIG. 2) does not include a guide member such that alignment of the carriage assembly 86 is maintained by the first, second, and third guide members 110, 114, 118. This arrangement allows the carriage assembly 86 to move freely along the Y-axis while inhibiting binding.

FIG. 2 shows the first guide member 110 engaged with the first guide rail 91. The first guide member 110 is fixed to the carriage frame 102 with a rod 122 with bearings (not shown) such that the first guide member 110 can rotate with respect to the carriage frame 102. The first guide member 110 engages the first guide rail 91 that has a T section and constrains the movement of the carriage assembly 86 with respect to the SRM frame 74 in the X-axis and the Z-axis such that the carriage assembly 86 can move in the Y-axis along the guide rail 90.

FIG. 3 shows the second guide member 114 engaged with the second guide rail 92. The second guide member 114 includes a first portion 126 and a second portion 130. The first portion 126 is fixed to the carriage frame 102 with a rod 122 with bearings (not shown), similar to the first guide member 110, such that the second guide member 114 can rotate with respect to the carriage frame 102. The first portion 126 also includes a T-shaped slot 135. The second portion 130 engages the second guide rail 92 that has a T section such that the second portion 130 is constrained in the X-axis and the Z-axis and moves freely along the Y-axis. The second portion 130 also includes a T-shaped protrusion 136 that engages the corresponding T-shaped slot 135 formed in the first portion 126. The first portion 126 can slide along the X-axis relative to the second portion 130 via the T-shaped slot and protrusion 135, 136 such that the second guide member 114 constrains the movement of the carriage assembly 86 with respect to the SRM frame 74 in the Z-axis but allows movement along the X-axis.

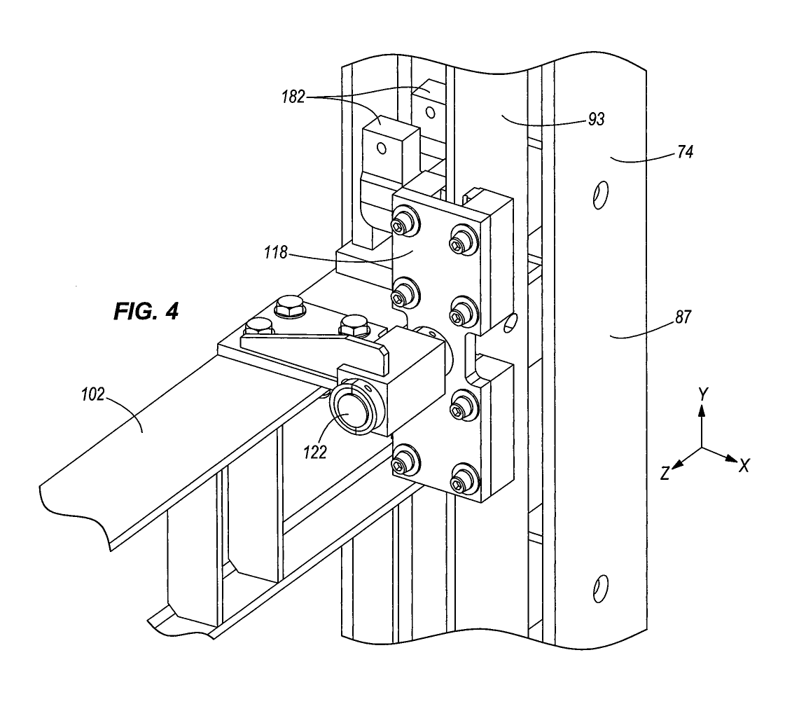

FIG. 4 shows the third guide member 118 engaged with the third guide rail 93. The third guide member 118 is fixed to the carriage frame 102 with a rod 122 with bearings (not shown) such that the third guide member 118 can rotate with respect to the carriage frame 102. The third guide member 118 engages the third guide rail 93 and constrains the movement of the carriage assembly 86 with respect to the SRM frame 74 in the X-axis such that the carriage assembly 86 can move in the Y-axis along the third guide rail 93. The third guide member 118 allows the carriage assembly 86 to translate slightly relative the third guide rail 93 along the Z-axis.

Referring to FIG. 1, the upper drive assembly 78 includes a vertical drive system 138 that moves the carriage assembly 86 relative to the SRM frame 74 along the Y-axis between the first level 38 and the fourth level 50, and a horizontal drive system 142 that moves the SRM 26 along the X-axis between the first position 54 and the fourth position 66.

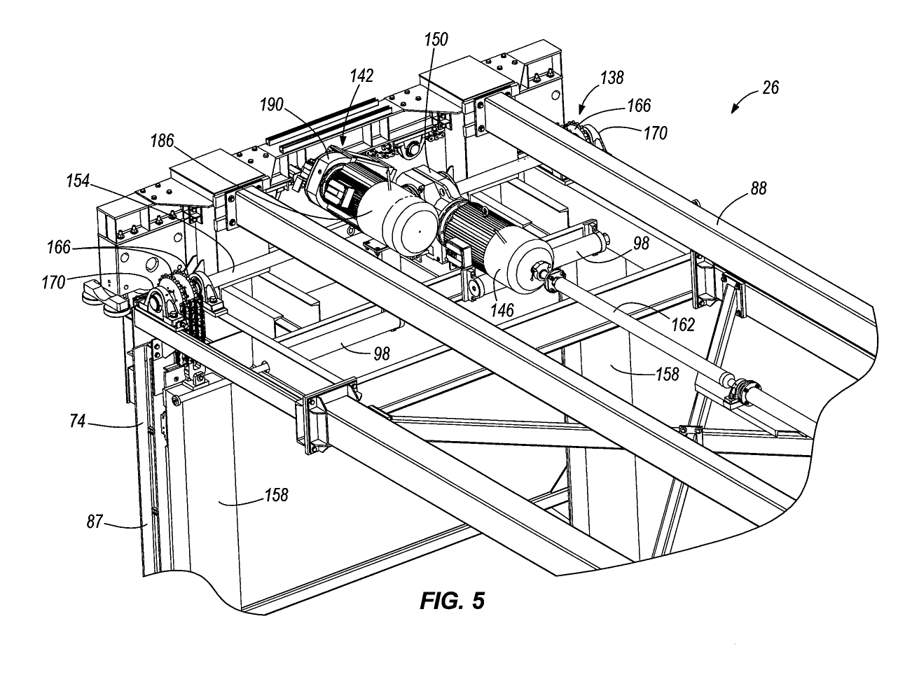

With reference to FIG. 5, the illustrated vertical drive system 138 includes a motor 146, a gear box 150, a drive shaft 154, and counterweights 158. FIG. 5 shows one side of the vertical drive system 138, and the opposite side of the upper drive assembly 78 includes an identical arrangement and the two motors 146 are coupled together with a synchronizer shaft 162. The synchronizer shaft 162 provides for the motors 146 to run synchronously and to move the carriage assembly 86 along the Y-axis smoothly. The illustrated motor 146 is an electric motor that drives the drive shaft 154 via the gear box 150. In other embodiments, the motor 146 may be a servo-motor and the synchronizer shaft 162 may be removed. The motor 146 may be any drive unit that moves the carriage assembly 86 along the Y-axis. For example, hydraulic cylinders are contemplated.

The drive shaft 154 is rotated by the motor 146 via the gear box 150 and includes four sprockets 166, two positioned on each end of the SRM frame 74, respectively. The drive shaft 154 is mounted to the SRM frame 74 with mounts 170 that allow the drive shaft 154 to rotate freely.

The illustrated counterweights 158 slide along the corresponding vertical columns 87 (along the Y-axis) of the SRM frame 74. Two chains 174 connect each weight 158 to the SRM frame 74. One end of each chain 174 attaches to a connecting portion 178 of the weight 158, loops over the sprocket 166, and attaches at the opposite end of the chain 174 to the carriage assembly 86 at connecting portions 182 (see FIGS. 2-4). Each corner of the carriage assembly 86 is lifted by two chains 174 (i.e., two chains 174 are attached to each weight 158 and each corner of the carriage assembly 86).

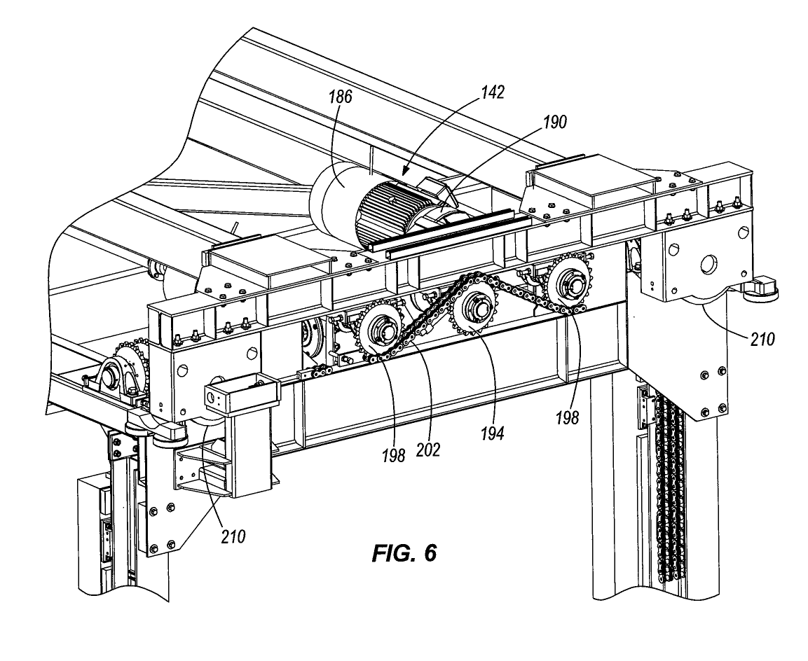

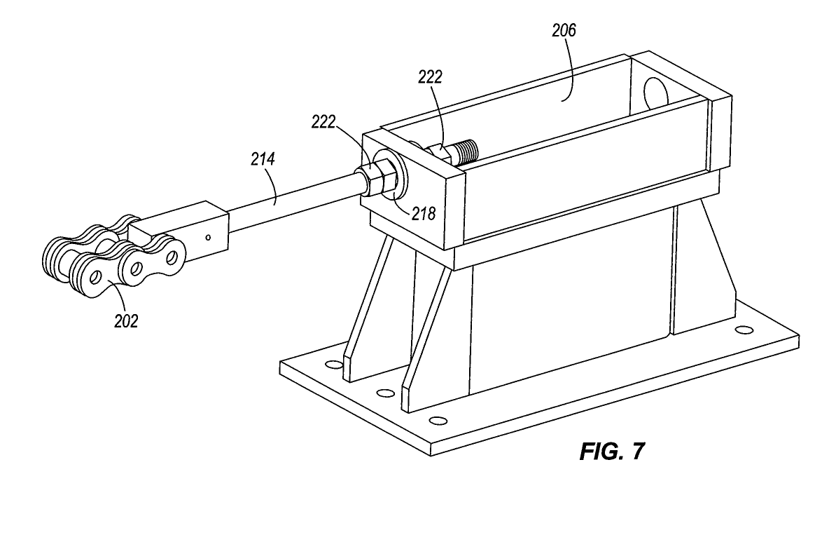

With reference to FIGS. 5 and 6, the illustrated horizontal drive system 142 includes a motor 186, a gear box 190 (see FIG. 5), a toothed element in the form of a drive sprocket 194, two idler sprockets 198, a flexible element in the form of a chain 202, two anchor points 206 (see FIGS. 1 and 7), and two wheels 210 that ride on the rails 70 of the support structure to support the SRM 26. FIG. 6 shows one side of the horizontal drive system 142, and the opposite side of the upper drive assembly 78 includes an identical arrangement. The illustrated motor 186 is an electric motor that drives the drive sprocket 194 via the gear box 190. The motor 186 may be any drive unit that moves the carriage assembly 86 along the X-axis. For example, hydraulic cylinders are contemplated.

The chain 202 includes a number of spaced recesses that the teeth of the sprockets 194, 198 engage. The chain 202 is stretched along the X-axis and mounted at the anchor points 206 (see FIG. 7) on opposite ends of the storage facility 10. The SRM 26 exerts a service load on the chain 202 while in operation and, in the illustrated embodiment, the chain 202 is pre-tensioned to a force greater than the service load to reduce the effects of the chain's 202 elasticity. For example, when the illustrated SRM 26 is accelerating along the X-axis, a force of about three thousand pounds is exerted on the chain 202. The illustrated chain 202 is pre-tensioned to about five thousand pounds. This pre-tension inhibits slack in the chain 202 during acceleration and stopping of the SRM 26 and reduces elastic elongation by at least about fifty percent.

The chain 202 also has a rated load that is a physical characteristic of the chain 202 and is set by the chain manufacturer. In the preferred embodiment, the chain 202 is pre-tensioned to at least forty percent of the rated load. In other embodiments, the chain 202 may be pre-tensioned differently, as desired. This pre-tension provides accurate positioning of the SRM 26 and at least partially avoids exaggerated chain 202 flexing.

The drive sprocket 194 and two idler sprockets 198 are arranged such that the chain 202 serpentines through the sprockets 194, 198 and maintains a desired angle of engagement with the sprockets 194, 198 during movement of the SRM 26. The drive sprocket 194 is driven by the motor 186 via the gear box 190 such that the SRM 26 is translated along the X-axis between the first position 54 and the fourth position 66. The idler sprockets 198 are mounted to the SRM frame 74 with bearings (not shown) such that they rotate freely and maintain the chain 202 in engagement with the drive sprocket 194.

With reference to FIG. 7, the anchor points 206 are fixed relative to the rail 70 and include a tensioning system to pre-tension the chain 202. The tensioning system includes a threaded rod 214, washers 218, and fasteners 222. The fasteners 222 are rotated on the threaded rod 214 to move the threaded rod 214 relative to the anchor point 206 such that the chain 202 is tensioned along the X-axis.

Referring to FIG. 1, the lower drive assembly 82 is mounted to the lower cage 89 and is similar to the horizontal drive system 142 of the upper drive assembly 78. The horizontal drive system of the lower drive assembly includes a motor, a gear box, a toothed element in the form of a drive sprocket, two idler sprockets, a flexible element in the form of a chain, and two anchor points. The lower drive assembly 82 operates in a manner similar to the horizontal drive system 142 of the upper drive assembly 78 to move the SRM 26 along the chain in the X-axis.

A control system 94 is coupled to the SRM 26 adjacent the upper drive assembly 78 and controls the movement of the SRM 26 in response to user input. The control system 94 may control the synchronization of the system to provide smooth operation. In other embodiments, the control system 94 may be located remotely or on another part of the SRM 26, as desired.

The invention provides several advantages over prior art SRMs. The chains 202 provide a built in shock absorber due to the chain 202 elasticity while minimizing the negative effects associated with chain elasticity by pre-tensioning the chain 202 above the maximum operational force. In other words, during normal operation, the chain 202 will not stretch an unreasonable amount because the pre-tension is above the normal service load. However, if the SRM 26 stops suddenly or experiences another abnormality, the chain 202 can absorb some of the shock by stretching beyond the pre-tension.

The chains 202 also avoid the alignment problems of many prior art designs. The chain 202 and sprocket 194, 198 arrangement does not require the tight tolerances required when using other systems (e.g., a rigid rack and pinion). As such, minor skewing of the SRM 26 will not cause substantial service damage. Additionally, previous systems required installation across the entire length of the SRM's 26 movement, whereas the chain 202 need only be fixed at two points at the ends of the rails 70. The anchor points 206 fix the chain 202 to the support structure (not shown) and pre-tension the chain 202. The chain 202 may be designed with self lubricating materials and/or materials that are highly resistant to corrosion such that prior art lubrication and corrosion problems may be avoided.

The operation of the illustrated embodiment will be described with respect to FIGS. 1. To initiate a storing operation, the product 30 is placed in the loading space 14. The control system 94 determines which storage location 22 the product 30 will be stored in and actuates the SRM 26. The product 30 is placed on the carriage assembly 86 and the SRM 26 is then ready to move to the appropriate level and position.

The horizontal drive systems 142 of the upper and lower drive assemblies 78, 82 then move the SRM 26 to the appropriate position (e.g., the third position 62). The motors 186 turn the drive sprockets 194 such that the SRM 26 is pulled along the chains 202 and rolled on the wheels 210 along the rails 70.

Once in the desired position (e.g., the third position 62), the SRM 26 moves the carriage assembly 86 to the desired level (e.g., the second level 42). The motors 146 turn the drive shaft 154 such that the sprockets 166 are turned and pull the carriage assembly 86 between the first level 38 and the fourth level 50 on the chains 174. As the carriage assembly 86 is raised the counterweights 158 are lowered to maintain contact between the chains 174 and the sprockets 166. The motors 146 continue to raise the carriage assembly 86 until the carriage assembly 86 is at the desired level (e.g., the second level 42).

Once located at the desired storage location 22, the product 30 is unloaded into the storage location 22, and the SRM 26 returns the carriage assembly 86 to the first level 38 and translates back to the loading space 14.

When it is desired to remove the product 30 from the storage facility 10, the control system 94 initiates a retrieval operation. The control system 94 will take an input from a user to determine which product 30 must be retrieved and where in the array that product 30 is located. Once the correct storage location 22 is determined, the SRM 26 translates along the X-axis to the appropriate position (e.g., the third position 62). The vertical drive system 138 then lifts the carriage assembly 86 to the appropriate level (e.g., the second level 42). Then the product 30 is loaded onto the carriage assembly 86, the vertical drive system 138 lowers the carriage assembly 86 to the first level 38, and the horizontal drive system 142 translates the SRM 26 to the loading space 14. Once the product 30 is placed in the loading space 14, the product 30 is removed to the holding area 34.

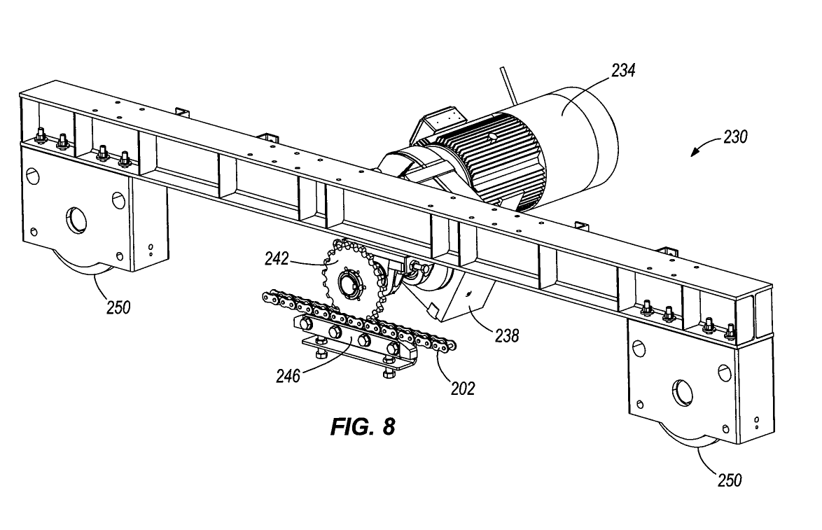

FIG. 8 shows an alternate horizontal drive system 230 that includes a motor 234, a gear box 238, a toothed element in the form of a drive sprocket 242, an idler shoe 246, a flexible element in the form of a chain 202, two anchor points 206 (same as shown in FIGS. 1 and 7), and two wheels 250 that ride on the rails 70 of the support structure to support the SRM 26. In operation, the idler shoe 246 moves with the horizontal drive system 230 to maintain the chain 202 in contact with the drive sprocket 242. The operation of the horizontal drive system 230 is similar to the operation of the horizontal drive system 142 described above.

Various features and advantages of the invention are set forth in the following claims.

What is claimed is:

1. A storage retrieval machine comprising:
an input area;
an array of storage locations;
an output area;
a carriage assembly adapted to hold a product when being transferred to and from the storage locations; and
a drive mechanism positioned to move the carriage assembly, the drive mechanism including:
a flexible element tensioned between two points and having a plurality of spaced recesses; and
a toothed element mounted to the carriage assembly and engaging the flexible element.

2. The storage retrieval machine of claim 1, wherein the flexible element is a chain.

3. The storage retrieval machine of claim 1, wherein the flexible element is secured at the two points, at least one of which is adjustable to adjust the tension on the chain.

4. The storage retrieval machine of claim 1, wherein the flexible element is tensioned to at least 10% of a rated load of the flexible element.

5. The storage retrieval machine of claim 1, wherein the flexible element is tensioned to at least 20% of a rated load of the flexible element.

6. The storage retrieval machine of claim 1, wherein the flexible element is tensioned to at least 30% of a rated load of the flexible element.

7. The storage retrieval machine of claim 1, wherein the flexible element is tensioned to at least 40% of a rated load of the flexible element.

8. The storage retrieval machine of claim 1, wherein the system has a maximum predicted service load, and wherein the flexible element is tensioned to a force greater than the service load.

9. The storage retrieval machine of claim 1, wherein the toothed element is mounted to a shaft, and wherein the drive mechanism further includes a power mechanism adapted to rotationally power the shaft.

10. The storage retrieval machine of claim 1, further including a rail, and wherein the carriage assembly further includes a plurality of wheels engaged to roll on the rail and support the carriage assembly on the rail.

11. A drive mechanism for a storage retrieval machine having an array of storage locations and a carriage assembly adapted to hold a product when being transferred to and from storage locations, the drive mechanism comprising:
a flexible element tensioned between two points and having a plurality of spaced recesses; and
a toothed element adapted to be mounted to the carriage assembly and in engagement with the flexible element.

12. The drive mechanism of claim 1, wherein the flexible element is a chain.

13. The drive mechanism of claim 1, wherein the flexible element is secured at the two points, at least one of which is adjustable to adjust the tension on the chain.

14. The drive mechanism of claim 1, wherein the flexible element is tensioned to at least 10% of a rated load of the flexible element.

15. The drive mechanism of claim 1, wherein the flexible element is tensioned to at least 20% of a rated load of the flexible element.

16. The drive mechanism of claim 1, wherein the flexible element is tensioned to at least 30% of a rated load of the flexible element.

17. The drive mechanism of claim 1, wherein the flexible element is tensioned to at least 40% of a rated load of the flexible element.

18. The drive mechanism of claim 1, wherein the system has a maximum predicted service load, and wherein the flexible element is tensioned to a force greater than the service load.
